(19) United States
(12) Patent Application Publication
(10) Pub. No.: US 2024/0116026 A1
(43) Pub. Date: Apr. 11, 2024

(54) VACUUM DRIVEN GEL FILTRATION METHOD

(71) Applicant: Waters Technologies Corporation, Milford, MA (US)

(72) Inventors: Donna Osterman, Northbridge, MA (US); Gabrielle Zabala, Attleboro, MA (US); Matthew A. Lauber, North Smithfield, RI (US); Jennifer M. Nguyen, Uxbridge, MA (US); Anna Boardman, Watertown, MA (US)

(73) Assignee: Waters Technologies Corporation, Milford, MA (US)

(21) Appl. No.: 18/483,253

(22) Filed: Oct. 9, 2023

Related U.S. Application Data
(60) Provisional application No. 63/414,673, filed on Oct. 10, 2022.

(51) Int. Cl. B01J 20/285

(52) U.S. Cl. CPC B01J 20/285; B01J 2220/62

(57) ABSTRACT

The present disclosure discusses a method of separating and/or purifying polynucleotides. The method includes injecting a sample into cartridge that is packed with a porous sorbent between opposing frits. Physical properties of the cartridge along with the use of hydrophilic fits allows efficient desalting of biopolymers using a vacuum to pull the sample through the cartridge.

### CROSS-REFERENCE TO RELATED APPLICATIONS

This application claims priority to and the benefit of U.S. Provisional Patent Application Ser. No. 63/414,673, entitled “Vacuum Driven Gel Filtration Method” and filed on Oct. 10, 2022; the contents of which are hereby incorporated by reference in their entirety.

### FIELD OF THE TECHNOLOGY

The present disclosure relates to the use of vacuum gel filtration for the preparation of samples prior to chromatographic analysis.

### BACKGROUND

Solid phase extraction (SPE) is a chromatographic technique that is widely used, e.g., for preconcentration and cleanup of analytical samples, for purification of various chemicals, and for removal of toxic or valuable substances from aqueous solutions. SPE is usually performed using a column or cartridge containing an appropriate material or sorbent. SPE procedures have been developed using sorbents that can interact with analytes by hydrophobic, ion-exchange, chelation, sorption, and other mechanisms, to bind and remove the analytes from fluids.

Processing of biological samples having proteins and other large biological molecules can be particularly difficult. The samples contain many other substances having a wide variety of properties. Prior to analysis of the sample, it is important to separate the molecules of interest (typically the larger biopolymers) from the other components in the sample. Typical methods used for sample preparation include use of gravity flow or positive pressure to force a sample through a sorbent, or centrifugal separations. Such processes can be lengthy and cumbersome. It is desirable to improve existing sample preparation processes.

### SUMMARY

The problems encountered in prior art devices can be overcome using vacuum assisted desalting of biological samples. Vacuum assisted desalting relies on a vacuum to pull the samples through the sorbent. A cartridge for desalting of a biological sample is used with a vacuum producing device to efficiently purify biopolymers.

In an embodiment, a desalting cartridge comprises a body, wherein the body is substantially cylindrical and hollow. The body has a first end and a second end opposite the first end. The cartridge also includes an outlet coupled to the second end of the body. A first frit is positioned in the body between the first end of the body and the second end of the body. The first frit is composed of a hydrophilic polymer. A second frit is also positioned in the body between the first frit and the second end of the body. A sorbent bed is disposed in the body between the first frit and the second frit. A storage solution is stored in the body between the first frit and the first end of the body. The second frit is at the second end of the body, between the body and the outlet. In some embodiments, the first end of the body comprises a flange. In an embodiment, the body has a length of about 2 inches (5 cm).

Both the first frit and the second frit are composed of a hydrophilic polymer. In some embodiments the first frit and/or the second frit are composed of hydrophilic polyethylene or hydrophilic polypropylene. In some embodiments, the first and second frits are composed of the same material. The first frit and/or the second frit have a nominal pore size of between about 5 μm to about 200 μm. The first frit and/or the second frit have a thickness of between about 0.5 mm to about 5 mm.

In an embodiment, the body is tapered such that the diameter of the body proximate the first end of the body is larger than the diameter of the body proximate the second end of the body.

The physical parameters of the cartridge can be optimized to promote rapid flow of the sample with high separation efficiency. In an embodiment, the ratio of the length of the desalting resin to a length of the body is between 0.5 and 0.6. In an embodiment, the bed aspect ratio of the cartridge is from about 4 to about 6. In an embodiment where the cartridge is about 2 inches (5 cm), a length of the sorbent bed is between about 1 inch (2.54 cm) and about 1.25 inches (3.175 cm) and an internal diameter of the body is between 0.2 inches (0.5 cm) and 0.25 inches (0.635 cm).

The sorbent can be a polymeric size exclusion sorbent. In a preferred embodiment, the sorbent is a dextran sorbent.

In an embodiment, a sample preparation system includes comprising a vacuum producing device and a cartridge as described herein.

In an embodiment, a method of obtaining biopolymers form a biologic sample comprises: obtaining a cartridge as described herein; applying a vacuum to the outlet of the cartridge to remove the storage solution from the cartridge; introducing the biologic sample into the cartridge after the storage solution is removed; and passing the biologic sample through the sorbent bed by applying a vacuum to the outlet to obtain biopolymers separated from salts and small molecule impurities present in the sample.

In an embodiment, the vacuum applied to the outlet during removal of the storage solution is about 3-5 inches Hg (10 kPa-17 kPa), which leads to a flow rate through the cartridge of 100 μL/sec to 150 μL/sec. In an embodiment, the vacuum applied to the outlet when passing the biologic sample through the desalting resin is between about 1-3 inches Hg (3.5 kPa-10 kPa), which leads to a flow rate of 50 μL/sec to 100 μL/sec.

In an embodiment, the method further comprises conditioning the desalting resin by adding a conditioning solution to the cartridge after the storage solvent is removed and applying a vacuum to the cartridge to pass the conditioning solution through the sorbent bed. The conditioning solution can be an aqueous buffer solution.

In an embodiment, passing the biologic sample through the desalting resin comprises eluting the biologic sample through the desalting resin by adding an elution solution to the cartridge and applying a vacuum to the cartridge to pass the eluting solution through the desalting resin. The elution solution can be an aqueous buffer solution.

In an embodiment, the biologic sample comprises one or more proteins.

In an embodiment, the desalted biologic sample is further analyzed using liquid chromatography or gas chromatography.

### BRIEF DESCRIPTION OF THE DRAWINGS

The technology will be more fully understood from the following detailed description taken in conjunction with the accompanying drawings, in which:

FIG. 1 is a schematic diagram of a vacuum based desalting system

FIG. 2 is a schematic diagram of a cartridge.

### DETAILED DESCRIPTION

To overcome the problems of prior sample preparation methods, a vacuum driven gel filtration cartridge and method was designed to quickly purify biological samples without damaging the biopolymers in the sample. The novel method uses a vacuum to pull the sample through a vacuum-resistant sorbent disposed in a cartridge. The sorbent is placed between two hydrophilic fits that both support the sorbent and promote rapid passage of the sample through the sorbent. The frits are optimized to provide ideal flow and rewetting if dried out.

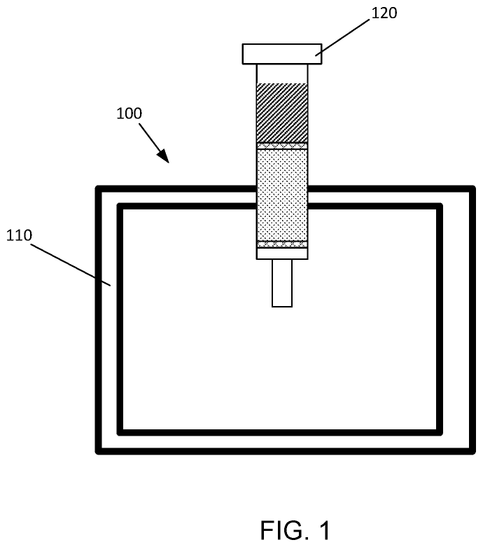

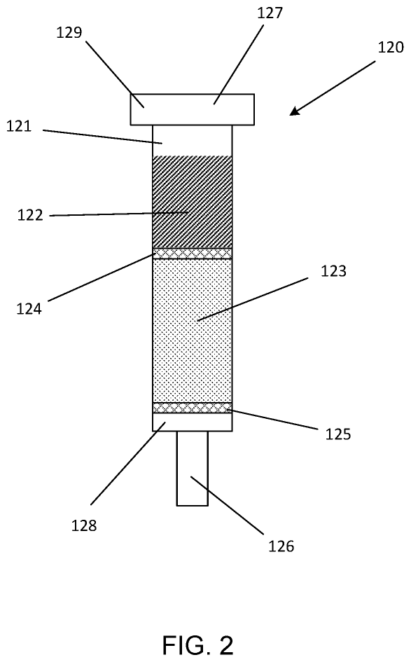

FIG. 1 depicts a schematic view of a sample preparation system 100. The sample preparation system comprises a vacuum producing device (e.g., a vacuum chamber 110) and a cartridge 120. Cartridge 120 may be filled with a sample or a solvent 122 (FIG. 2) prior to applying a vacuum to the cartridge. Once the vacuum is applied, the sample (or solvent) is pulled through the cartridge allowing the sorbent bed 123 to separate the sample into different fractions.

In an embodiment, the sample includes one or more biopolymers. As used herein a biopolymer is a polymer produced by the cells of living organisms. Biopolymers are composed of monomeric units that are covalently bonded to form larger molecules. Exemplary biopolymers include, but are not limited to, polynucleotides (e.g., DNA, RNA, mRNA, etc.), polypeptides (e.g., proteins and enzymes), and polysaccharides (e.g., starch, cellulose and alginate). In some analytical methods it is desirable to purify biopolymers before performing a chromatographic analysis. One such process is desalting of the sample. Desalting, as used herein, is a process that separates soluble biopolymers from salts and smaller molecules. Desalting methods are based on size exclusion chromatography. Size exclusion chromatography relies on differences in size between the biopolymers and the pores in the sorbent. The maximum effective pore size (exclusion limit or molecular weight cut off (MWCO) of the sorbent) determines the size of molecules that can be separated. Molecules that are significantly smaller than the MWCO penetrate into the pores of the sorbent, while molecules larger than the MWCO are unable to enter the pores and pass through the sorbent. By passing samples through a sorbent bed with sufficient length and volume, biopolymers can be fully separated from small molecules quickly and without damage to the biopolymers.

An embodiment of a cartridge for desalting is depicted in FIG. 2. Cartridge 120 comprises a body 121. Body 121 is substantially cylindrical and hollow. Body 121 has a first end 127, which is configured to receive a sample to be tested. Body 121 also has a second end 128, through which a sample can exit. First end 127 has an opening that is substantially surrounded by a flange 129. Flange 129 can be used to hold the body in place during use. For example, flange 129 may have a shape and size that fits into a holder of a sample purification system. A flanged end can prevent the cartridge from moving during purification of the sample.

A sorbent 123 is placed in the cartridge body between a first frit 124 and a second frit 125. Sorbents that are useful for the separation of biopolymers rely on size exclusion to separate the larger biopolymers from salts and small molecules in the desalting process. Size exclusion sorbents are made from porous particles that have a pore size that is substantially smaller than the biopolymers that are present in the sample, but large enough to retain the salts and smaller molecules that are also in the sample. Sorbents that are useful for the purification of biopolymers have a size exclusion limit of about 5000 Da or smaller. Larger size exclusion limits (e.g., up to about 40,000 Da) can be used to separate larger proteins from smaller proteins. Exemplary sorbents that are used for the purification of biomolecules include polysaccharide resins (e.g., dextran resins) and polyacrylamide resins.

The sorbent is disposed in the body, between first frit 124 and second frit 125. First frit is positioned between first end 127 of the body and the second end 128 of the body. Second frit is positioned between first frit 124 and second end 128 of the body. First and second frits can be formed from a hydrophilic polymer. For example, first and second frits can be made from hydrophilic polymer. Preferred polymers for use in forming the first and second frits are hydrophilic polyolefins (e.g., hydrophilic polyethylene and hydrophilic polypropylene). First frit and second frit can be composed of different hydrophilic polymers or the same hydrophilic polymers. In an embodiment, the first and/or second first have a nominal mean pore size of between about 5 μm to about 200 μm. The first and second frits have a diameter approximately equal to the interior diameter of body 121. Frits can be floating or retained by an interference fit with the interior surface of the body. In some embodiments, body 121 is tapered such that the diameter of the body narrows from the first end toward the second end allowing the fits to be retained at specific locations in the body by setting the diameter of the frit to be slightly larger that the diameter of the body at a specific location. The thickness of the frit may also be varied from between about 0.5 mm to about 5 mm. Further modifications of the frits for optimization of the sample purification process include varying pore size (between about 5 μm and 200 μm) as needed to retain the resin particles, pore shape, pore volume, coating or surface treatment to create/maintain hydrophilicity (e.g., plasma treatment, silane coating, etc.), and frit shapes (cylindrical, spherical, frusto-conical, etc.). Furthermore, while two frits are shown in the examples presented herein, more than two frits could be utilized per cartridge. To minimize the void volume of the cartridge, the second frit can be placed proximate to the second end of the body, between the body and outlet 126.

Design parameters of the cartridge can be adjusted to increase efficiency and decrease permeability when using vacuum-assisted flow control. Two device factors that can directly impact the efficiency and liquid flow are larger resin bed aspect ratio and hydrophilic frits. The use of hydrophilic fits offered a number of unexpected advantages over hydrophobic frits. For example, vacuum assisted desalting protocols on 1 mL cartridges took about two to four minutes to be completed when hydrophobic frits were employed, but only approximately 1 minute when hydrophilic frits were incorporated into the device design. In addition to this flow rate and time advantage, it was found that devices constructed with hydrophilic frits produce higher, more reproducible protein recoveries.

The bed aspect ratio is the length of the bed/diameter of bed. In general, current spin- and gravity-based column offerings have small aspect ratios, providing less efficient separation. With a bed having a larger aspect ratio, more theoretical plates can be observed, resulting in greater separation efficiency. In an embodiment, the bed aspect ratio is selected to be from about 4 and 6. For example, a cartridge having a 2.17″ inch (5.51 cm) body and a tapered internal diameter between 0.2 inches (0.5 cm) and 0.25 inches (0.635 cm) can have an optimized bed aspect ratio when the bed is between 1 inch (2.54 cm) and 1.25 inches (3.175 cm).

Cartridge bodies have a length and internal volume sufficient to hold the proper amount of sorbent for sample preparation. Cartridges also can have an external shape that allows them to be coupled to a cartridge holder that allows manual or automated dispensing of the sample into the cartridge. In some embodiment, the cartridge may be “flangeless.” A flangeless cartridge can be arranged in a standard 96-well plate format (9 mm center to center), allowing for automation capabilities (interfacing with modern liquid handlers, for example) and for seamless integration with downstream analysis that could use a similar format.

Typically, the cartridges described herein are intended for analysis of relatively small volumes of samples. Typical sample volumes can be from 20 μL up to 2.5 mL, depending on the amount of sorbent in the cartridge.

Another design parameter of the cartridges that can be optimized is the ratio of the length of the sorbent bed to the length of the cartridge. In an embodiment, the ratio of the length of the sorbent bed to the length of the body is from 0.5 to 0.6. For example, in one embodiment, the cartridge is approximately 2 inches (5 cm) in length. The 2-inch cartridge may have up to 200 mg of sorbent in the sorbent bed. The optimal length of the sorbent bed in the cartridge is between 1 in and 1.25 in.

An outlet 126 can also be coupled to body 121. The outlet concentrates the sample that passes through the sorbent bed and directs the sample into a suitable collection vessel. The size of the outlet can be selected to optimize the flow. For example, the outlet could be wide to allow for faster flow. Alternatively, the outlet can be a luer fitting. A luer fitting can be used to attach to a downstream vessel for analysis. A narrow outlet can be used to create smaller droplet volumes for final collection of the sample. The outlet can also be configured to couple to a vacuum source. For example, a vacuum manifold having one or more cartridge holders, and a corresponding number of collection sites, may include sites for the outlet to be attached to the manifold in a way that the vacuum can be applied to the cartridge.

A cartridge may also include a storage solution 122 that is stored in the body 121, between the first frit 124 and the first end 127 of the body. A storage solution can aid in ensuring that the sorbent bed remains wetted and the frit maintains hydrophilicity before use. The storage solution is typically chosen to match the solution that is used in the sample. For example, a biological sample may be suspended in a physiological pH buffer solution. A storage solution may then be selected to match the buffer solution used in the sample. Furthermore, the storage solution can be selected to maintain the hydrophilicity of the frits. Water and aqueous buffer solutions are typically used to maintain the hydrophilicity of the frits. Storage solution can also include one or more compounds that prevent microbial contamination.

The operation of the vacuum system and cartridge shown in FIG. 1 for desalting a sample is described below. A cartridge is obtained having a sorbent bed and physical parameters that are optimal for the desalting process. Physical parameters include parameters such as length of the cartridge, length of the sorbent bed, diameter of the cartridge, bed aspect ratio, frit mean pore size, frit thickness, and frit material. The cartridge is placed into the vacuum producing device 110 and a vacuum is applied to the cartridge to remove the storage solvent from the cartridge. A biological sample having one or more biopolymers is added to the cartridge after the storage solvent is removed. The sample is passed through the sorbent bed by applying a vacuum to the outlet to obtain biopolymers separated from salts and small molecule impurities.

In this process, the vacuum applied to the outlet is selected to create an optimal flow rate of the sample through the sorbent bed, while maintaining the integrity of the sorbent bed. In typical examples, the vacuum applied during removal of the storage solution is between 3 inches Hg and 5 inches Hg. For a typical cartridge made according to the design parameters described herein, the storage solvent can be removed at a rate from 100 μL/sec to 150 μL/sec. For passage of the biological sample through the cartridge the vacuum is increased to accommodate the slower diffusion rates of the biopolymers through the sorbet. For example, in one embodiment, the vacuum is set from 1 inch to 3 inches of Hg to pull the sample through the cartridge, so the sample passes through the cartridge at a rate from 50 μL to 100 μL/sec, less than the flow rate of the storage solution (100-150 μL).

Before and/or after one or more biological samples are passed through the cartridge, the cartridge can be conditioned with conditioning solution. A conditioning solution can be added to the cartridge after use. The conditioning solution is passed through the sorbent bed and then used to fill the cartridge. A vacuum is typically used to pull the conditioning solution through the cartridge. The conditioning solution is typically water or an aqueous buffer solution.

Biological samples may not have sufficient volume of fluid to pass through the cartridge. In some embodiments, an eluting solution is used to pass the biologic sample through the desalting resin. An elution solution is applied to the cartridge and a vacuum is applied to the cartridge to pass the eluting solution through the sorbent bed. Passage of the eluting solution through the sorbent bed ensures that most of the biological sample passes through the sorbent bed. Typical elution solutions include water and aqueous buffer solutions.

After the biopolymers have been obtained by passage through the cartridge, the samples may be further analyzed by introducing the desalted sample into a chromatography column. The desalted biological samples can be introduced into a liquid chromatography or gas chromatography system.

### EXAMPLES

### Example 1—Vacuum Desalting Process

A cartridge having a cross-linked dextran sorbent having a storage solution was attached to a vacuum manifold. The cross-linked sorbitan was disposed between two hydrophilic frits. After the caps on the cartridge were removed, a vacuum of 3-5 inches Hg (10 kPa-17 kPa) was applied to the cartridge to completely remove the storage solution. Under these vacuum conditions, the storage solution was removed at a rate of about 100 μL/sec to 150 μL/sec. A phosphate buffer saline conditioning solution (400 μL) was added to the cartridge and pulled through the cartridge using an applied vacuum of between 3-5 inches Hg (10 kPa-17 kPa). A sample was loaded into the cartridge. In this example, the sample was bovine serum albumin (100 μL of a 1 mg/mL solution). A vacuum of 1 inch Hg (3.5 kPa) was applied to the cartridge. Under this condition, the sample was pulled through the cartridge at a rate of about 50 μL/sec. The sample was eluted through the sorbent bed with a phosphate buffer saline solution (370 μL).

### Example 2—Gravity Flow Desalting Process

A cartridge having a cross-linked dextran sorbent having a storage solution was stored on a rack in a vertical position. The cross-linked sorbitan was disposed between two hydrophilic frits. Any caps on the cartridge were removed and the storage solution was allowed to completely drain from the cartridge. Under gravity flow conditions, the solution flow through the cartridge was 100 μL/min to 150 μL/min. A phosphate buffer saline conditioning solution (400 μL) was added to the cartridge and allowed to flow out of the cartridge. A sample was loaded into the cartridge. In this example, the sample was bovine serum albumin (100 μL of a 1 mg/mL solution). Gravity flow was used to introduce the sample into the sorbent bed. The cartridge was washed by a phosphate buffer saline (100 μL) by adding the buffer and allowing the buffer to flow into the sorbent. The sample was eluted through the sorbent bed with a phosphate buffer saline solution (300 μL) using gravity flow.

### Example 3—Vacuum Desalting vs. Gravity Desalting

Table 1 shows the protein recovery (bovine serum albumin) from four separate runs of the vacuum desalting process of Example 1. Table 2 shows the average protein recovery for the vacuum desalting process of Example 1.

TABLE 1

| Test Run | Absorbance | BSA Conc. (mg/mL) | % Protein Recovery |
|---|---|---|---|
| #1 | 0.161 | 0.213 | 87.04 |
| #2 | 0.147 | 0.182 | 78.38 |
| #3 | 0.172 | 0.237 | 94.76 |
| #4 | 0.173 | 0.240 | 91.45 |

TABLE 2

| Protein | Avg. Protein | Protein | Protein | Avg. % | Protein |
|---|---|---|---|---|---|
| Conc. | Conc. | Conc. | Recovery | Protein | Recovery |
| Std. Dev. | (mg/mL) | % RSD | % RSD | Recovery | Std. Dev. |
| 0.027 | 0.218 | 12.31 | 8.07 | 87.91 | 7.10 |

Table 3 shows the protein recovery (bovine serum albumin) from eight separate runs of the gravity desalting process of Example 2. Table 4 shows the average protein recovery for the gravity desalting process of Example 2.

TABLE 3

| Test Run | Absorbance | BSA Conc. (mg/mL) | % Protein Recovery |
|---|---|---|---|
| #1 | 0.203 | 0.275 | 80.65 |
| #2 | 0.192 | 0.253 | 73.82 |
| #3 | 0.207 | 0.282 | 78.73 |
| #4 | 0.188 | 0.245 | 70.95 |
| #5 | 0.206 | 0.280 | 80.78 |
| #6 | 0.189 | 0.247 | 71.63 |
| #7 | 0.190 | 0.249 | 71.86 |
| #8 | 0.193 | 0.255 | 73.08 |

TABLE 4

| Protein | Avg. Protein | Protein | Protein | Avg. % | Protein |
|---|---|---|---|---|---|
| Conc. | Conc. | Conc. | Recovery | Protein | Recovery |
| Std. Dev. | (mg/mL) | % RSD | % RSD | Recovery | Std. Dev. |
| 0.016 | 0.261 | 6.10 | 5.55 | 75.19 | 4.17 |

As noted in Examples 1 and 2, vacuum assisted desalting of the protein sample was much quicker than gravity flow. In addition, as shown in Tables 1-4, the average protein recovery was much higher for vacuum assisted desalting than for gravity flow desalting.

### Example 4—Vacuum Filtration with Hydrophobic Versus Hydrophilic Fritted Cartridges

Gel filtration desalting devices were fabricated from 1 cc syringe barrels, crosslinked dextran media and either two top and bottom placed hydrophobic polyethylene frits or two hydrophilic polyethylene frits. Vacuum assisted flow was generated through the use of a vacuum manifold and vacuum pump pulling a pressure differential of approximately −1 pound per square inch. Bovine serum albumin (BSA) was desalted according to the following procedure. Protein recovery was measured through the use of an UV-Vis plate reader instrument. Four desalting devices of each type were tested on two different days. The averaged results for these experiments are shown below.

### Protocol

1.) Turn on vacuum manifold and set to lowest possible setting (−1 PSI)
2.) Drain storage buffer to waste
3.) Equilibrate: Add 1200 μL 0.1M Tris-HCl. (400 μL, 3 times), draining to waste vessel
4.) Sample load: Add 100 μL 1 mg/mL BSA in 6M Guanidine HCl sample, draining to waste vessel
5.) Stacker: Add 100 μL 0.1M Tris-HCl, draining to waste vessel
6.) Shutoff vacuum manifold and replace waste vessel with collection vessel
7.) Turn vacuum manifold on without adjustment
8.) Elute: Add 300 μL 0.1M Tris-HCl, eluting to collection vessel/vessels

### Data and Results

TABLE 5
Run 1

| | | Sample | Avg. | | |
|---|---|---|---|---|---|
| | Sample | Concen- | Protein | Protein | Protein |
| | Vol | tration | Recovery | Recovery | Recovery |
| Frit | (μL) | (mg/mL) | (mg/mL) | STDEV | RSD |
| Hydrophobic | 100 | 1.00 | 51.17 | 12.5398 | 24.51 |
| Hydrophilic | 100 | 1.00 | 61.83 | 6.6700 | 10.79 |

TABLE 6
Run 2: Same experiment on different day

| | | Sample | Avg. | | |
|---|---|---|---|---|---|
| | Sample | Concen- | Protein | Protein | Protein |
| | Vol | tration | Recovery | Recovery | Recovery |
| Frit | (μL) | (mg/mL) | (mg/mL) | STDEV | RSD |
| Hydrophobic | 100 | 1.00 | 36.69 | 14.9948 | 37.78 |
| Hydrophilic | 100 | 1.00 | 59.59 | 8.8616 | 14.87 |

Vacuum assisted desalting protocols on these 1 cc desalt cartridges took about two to four minutes to complete when hydrophobic frits were employed but only approximately 1 minute when hydrophilic frits were incorporated into the device design. In addition to this flow rate and time advantage, it was found that devices constructed with hydrophilic frits produce higher, more reproducible recoveries. Protein recovery was observed to be 51 and 37% when vacuum assisted desalting was performed with hydrophobic frits on different days. RSDs for these recoveries were inordinately high as well, at 25 and 38%, respectively. In comparison, the hydrophilic frits devices yielded recoveries of 62 and 60% with corresponding RSDs of 11 and 15% with experiments performed on separate days.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A desalting cartridge comprising:
a body, wherein the body is substantially cylindrical and hollow, and wherein the body comprises a first end and a second end opposite the first end;
an outlet coupled to the second end of the body;
a first frit positioned in the body, wherein the first frit is composed of a first hydrophilic polymer, and wherein the first frit is positioned between the first end of the body and the second end of the body;
a second frit positioned in the body, wherein the second frit is composed of a second hydrophilic polymer, and wherein the second frit is positioned between the first frit and the second end of the body;
a sorbent bed disposed in the body between the first frit and the second frit; and
a storage solution stored in the body between the first frit and the first end of the body.

2. The cartridge of claim 1, wherein the first end of the body comprises a flange.

3. The cartridge of claim 1, the first frit and/or the second frit are composed of hydrophilic polyethylene or hydrophilic polypropylene.

4. The cartridge of claim 1, wherein the first and second frit are composed of the same material.

5. The cartridge of claim 1, wherein the first frit and/or second frit have a nominal mean pore size of between about 5 μm to about 200 μm.

6. The cartridge of claim 1, wherein the first frit and/or the second frit have a thickness of between about 0.5 mm to about 5 mm.

7. The cartridge of claim 1, wherein the second frit is positioned at the second end of the body, between the body and the outlet.

8. The cartridge of claim 1, wherein the body is tapered such that the diameter of the body proximate the first end of the body is larger than the diameter of the body proximate the second end of the body.

9. The cartridge of claim 1, wherein a ratio of a length of the desalting resin to a length of the body is between 0.5 and 0.6.

10. The cartridge of claim 1, wherein the body has a length of about 2 inches (5 cm).

11. The cartridge of claim 1, wherein the bed aspect ratio of the cartridge is from about 4 to about 6.

12. The cartridge of claim 10, wherein a length of the sorbent bed is between about 1 inch (2.54 cm) and about 1.25 inches (3.175 cm), when an internal diameter of the body is between 0.2 inches (0.5 cm) and 0.25 inches (0.635 cm).

13. The cartridge of claim 1, wherein the sorbent is a size exclusion sorbent.

14. The cartridge of claim 13, wherein the sorbent is a dextran sorbent.

15. A sample preparation system comprising a vacuum producing device and a cartridge as described in claim 1.

16. A method of obtaining biopolymers from a biologic sample, the method comprising:
obtaining a cartridge as described in claim 1;
applying a vacuum to the outlet of the cartridge to remove the storage solution from the cartridge;
introducing the biologic sample into the cartridge after the storage solution is removed; and
passing the biologic sample through the sorbent bed by applying a vacuum to the outlet to obtain biopolymers separated from salts and small molecule impurities present in the sample.

17. The method of claim 16, wherein the vacuum applied to the outlet during removal of the storage solution is between about 3-5 inches Hg (10 kPa-17 kPa).

18. (canceled)

19. The method of claim 16, wherein the vacuum applied to the outlet when passing the biologic sample through the desalting resin is between 1-3 inches Hg (3.5 kPa-10 kPa).

20. (canceled)

21. The method of claim 16, wherein the method further comprises conditioning the desalting resin by adding a conditioning solution to the cartridge after the storage solvent is removed, and applying a vacuum to the cartridge to pass the conditioning solution through the sorbent bed.

22. (canceled)

23. The method of claim 16, wherein passing the biologic sample through the desalting resin comprises eluting the biologic sample through the desalting resin by adding an elution solution to the cartridge and applying a vacuum to the cartridge to pass the eluting solution through the desalting resin.

24. (canceled)

25. (canceled)

26. (canceled)

27. (canceled)
